(19) United States
(12) Patent Application Publication
(10) Pub. No.: US 2003/0003866 A1
(43) Pub. Date: Jan. 2, 2003

(54) Wireless communication device and method

(76) Inventors: Mike Overy, Alton (GB); Jarmo Hietanen, Espoo (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/946,526

(22) Filed: Sep. 6, 2001

(30) Foreign Application Priority Data
Jun. 29, 2001 (GB) 0115979.7

(51) Int. Cl. H04B 5/00

(52) U.S. Cl. 455/41; 455/403

(57) ABSTRACT

A method of wirelessly communicating between a first and second device is disclosed, as well as devices for carrying out the method. The method has the steps of: transmitting a first set of data from the first device to the second device using a radio signal; and transmitting a second set of encoded data from the first device to the second device using an acoustic signal. The first set of data comprises information related to the encoding of the second set of data.

### BACKGROUND OF THE INVENTION

This invention relates to a technique using sound-producing and detecting devices for enhancing the functionality of a portable radio device, particularly a telephone or other radio communication device. It finds particular utility when used in conjunction with devices employing local wireless radio technology, such as Bluetooth. Throughout this specification, ‘acoustic’ is intended to include pressure waves—both audible and inaudible. It specifically includes ultrasound as well as sounds in the audible spectrum.

Portable devices are available which employ Bluetooth low power RF technology to allow point to point transmissions from one device to another. Typical uses for Bluetooth include PC-printer connections, PC-telephone connections and electronic or mobile-commerce (e-commerce/m-commerce).

Bluetooth has a range which can be measured in meters or tens of meters, and while this is suitable for some applications, certain other applications require a shorter range for a variety of reasons.

One such application is m-commerce, where a user may use a suitably equipped portable telephone or wireless device to authorise payment. A problem with such a system lies in the fact that at a retail outlet payment point, there may be many users seeking to pay using their suitably equipped device and, if they all operate within the range of the payment point, possible security and access problems may occur. An example of such a scenario is a fast food outlet where there may be many pay points, and many people waiting in line to pay. In such a situation, the number of potential handsets may be huge.

The problem in such a situation becomes trying to establish a bi-directional communication link only with the desired party and not a bystander.

### SUMMARY OF THE INVENTION

According to a first aspect of the present invention there is provided a method of wirelessly communicating between a first and second device, comprising the steps of: transmitting a first set of data from the first device to the second device using a radio signal; and transmitting a second set of encoded data from the first device to the second device using an acoustic signal, wherein the first set of data comprises information related to the encoding of the second set of data.

According to a second aspect of the present invention there is provided a device for communicating wirelessly, comprising: a first receiver arranged to receive a radio transmission comprising a first set of data; a second receiver arranged to receive an acoustic transmission comprising a second set of encoded data; a processor arranged to decode the second set of data utilising information from the first set of data.

According to a third aspect of the present invention there is provided a device for communicating wirelessly, comprising: a first transmitter arranged to transmit a radio signal comprising a first set of data; a second transmitter for transmitting an acoustic signal comprising a second set of data encoded using information from the first set of data.

Advantageously, embodiments of the present invention allow proximity measurement to be made in a straightforward manner using portable wireless devices. Applications for such devices include any situation where security of transaction and the relative proximity of the two parties is important.

In a preferred embodiment, RF and ultrasonic signal are used in co-operation with each other to ensure that defined and/or identified parties are able to communicate in a secure manner.

In another preferred embodiment, RF and ultra wide sound (UWS) signals are used for communication in a similar fashion to the ultrasound embodiment.

UWS is a system utilising short pulses, preferably single cycles, of sound from the audible part of the audio spectrum. Such pulses are not as directional as ultrasound signals and this can offer advantages in certain scenarios.

UWS enables devices to communicate using currently available and commonly used transducers such as microphones and loudspeakers commonly found in portable telephones.

The UWS signals occupy a wide bandwidth, but are of low amplitude, rendering them inaudible to the human ear. However, a suitably arranged receiver is able to discern the pulses and reconstruct a digital signal which conveys information.

Various statistical techniques may be employed to improve the reliability of the UWS communication link. A simple technique requires repetition of the transmitted pulses at defined intervals. The receiver is then able to perform a statistical analysis on the most likely value of a given pulse.

Error correction and detection techniques may also be employed to make the communication link more robust.

In different embodiments, different devices may be equipped with only acoustic receivers, transmitters or both.

Embodiments of the invention provide advantages where it is necessary to provide secure communication between two devices within a defined range. The acoustic signal provides the means by which proximity may be determined, and both acoustic and radio signals may be encoded to ensure that communications are secure.

Situations where such security and proximity requirements are needed is in secure payment using a portable device as a payment device, controlled entry into restricted areas and access to a compute system.

### BRIEF DESCRIPTION OF THE DRAWINGS

For a better understanding of the present invention, and to understand how the same may be brought into effect, the invention will now be described, by way of example only, with reference to the appended drawings in which:

FIG. 1 shows a base and mobile unit according to an embodiment of the invention;

FIG. 2 shows the differential propagation times of acoustic and radio waves;

FIG. 3 illustrates an embodiment of the invention used in authorising access to a secure area;

FIG. 4 shows an example of an ultra wide sound signal; and

FIG. 5 illustrates the timeslot nature of an ultra wide sound signal.

### DETAILED DESCRIPTION OF THE INVENTION

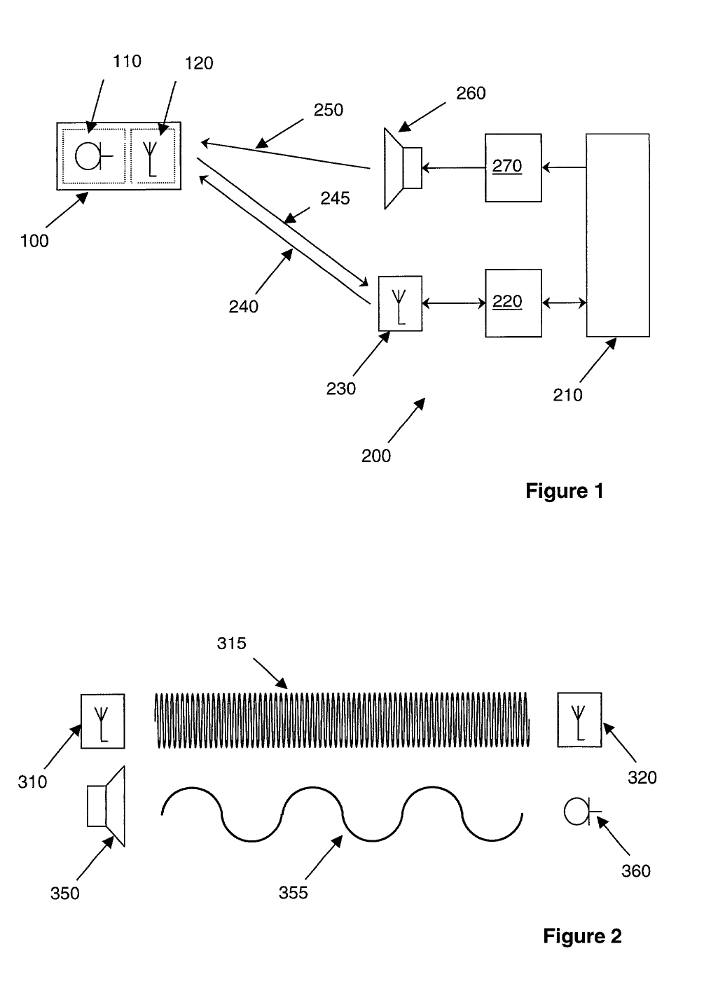

FIG. 1 shows a block diagram of certain elements of a system employing both Bluetooth low power RF signalling and sound or acoustic signalling. Bluetooth is known as a scheme by which low power RF signals may be exchanged between suitably equipped devices for the transfer of information. Other low power RF communication schemes are known or envisaged which are also suitable.

The Bluetooth equipped devices 100, 200 are further equipped to include acoustic signalling capabilities. In this embodiment, the acoustic signalling utilises ultrasound pressure waves, which are inaudible to the human ear, but which may be generated and received using either custom ultrasound devices, or hybrid audible sound and ultrasound transducers. Such hybrid devices may replace the earpiece and microphone customarily found in portable telephone devices.

The system comprises two major elements: a terminal device 100, and a base unit 200. The terminal device may be a portable telephone, a personal computer, a personal organiser or other portable electronic apparatus. In a particular embodiment, the portable device is an enhanced personal telephone, arranged to include identity data linking it closely with one or more individuals. The enhanced telephone has the capability, amongst other things, to perform and authorise electronic payment and open security doors to which its owner has access.

The terminal 100 comprises RF circuitry 120 enabling it to communicate via the Bluetooth communication standard. Bluetooth is primarily intended for use in a point-to-point manner over relatively short distances—a few meters to a few tens of meters.

As previously mentioned a problem with radio technology used for transactions such as payment or allowing access to secure areas, is that it can prove difficult to determine exactly which terminal is currently being communicated with if there are several within range of the requesting device, e.g. a door to secure area.

Sound waves, however, have a shorter range than radio waves, and it is generally simpler to calculate the distance from which a sound transmission was made by measuring the difference in time between reception of a radio signal, and reception of a sound signal.

This is illustrated in FIG. 2. Antenna 310 is used to transmit a radio signal 315. The signal is received by antenna 320 some time later. The radio wave travels at the speed of light and over a short distance, its time of arrival may be considered to be instantaneous.

Ultrasound transducer 350 emits an ultrasound signal 355 simultaneously with the radio signal 315. As the ultrasound signal only travels at the speed of sound, it arrives significantly later than the radio signal. The difference in time of arrival of the two signals 315, 355 is directly proportional to the distance between the receiving and transmitting devices.

By measuring the times difference (Δt) between the two received signals, it is possible to calculate the proximity of the terminal. In this way, only a terminal 100 positioned within a defined radius of the base unit 200 may be authenticated.

As an alternative to transmitting the radio and ultrasound signals simultaneously, there may be a defined time relationship between them. For instance, the system may be configured such that the ultrasound signal is always transmitted a certain period after the radio signal is transmitted. If the receiving device knows this period, then the proximity may be calculated on this basis. Alternatively, the period between the radio and ultrasound transmissions may be explicitly specified in the initial radio transmission.

Returning to FIG. 1, a typical sequence of events may be as follows. The base unit controller 210 transmits, via a Bluetooth unit 220 and transmitter 230, a signal 240 for reception by the Bluetooth unit 120 of terminal 100.

The signal 240 comprises information concerning a sound transmission which follows the RF transmission, or is sent simultaneously. Such information may comprise details of the encoding of the acoustic signal. The encoding ensures that the terminal 100 is prepared for a transmission on a particular frequency, or having a certain encoding scheme or comprising a certain key signature.

On receipt of signal 240, the terminal 100 updates its internal memory with the details of the impending sound transmission, and is then prepared to receive a signal in a now known format.

The base unit then sends the sound signal 250 via sound processor 270 and ultrasound transducer 260. The acoustic signal 250 is received by ultrasound transducer 110 at the terminal 100. The time of arrival can be determined, and on that basis the distance between the two devices can be calculated. If the proximity threshold is satisfied, and the received sound signal correlates with the data already identified in RF transmission 240, then the terminal 100 transmits an RF signal 245 verifying that the signals correlate, and the base unit can then authorise the requested transaction.

As highlighted before, the transaction may involve authorising payment, opening a secure door or any other activity where security and proximity need to be confirmed.

FIG. 3 illustrates a secure access scenario—the base unit 200 may be located adjacent a secure door to which only certain pre-defined people have access. The base unit 200 may periodically transmit a radio signal requesting all devices in its range—e.g. within 5 meters of the door—to identify themselves also via a radio signal. Obviously, not everyone within the 5 m range is going to want to pass through the door—some people may pass by. However, if the base unit 200 is aware in advance of who is likely to want to enter, it can choose to ignore those people who have no access rights.

With such a system, firstly, it is not possible to accurately measure or calculate proximity using the Bluetooth signal alone as there is no simple way of measuring propagation time to the required degree of accuracy. Secondly, it is not possible to perform a proximity measurement using received signal strength as there too many variables which could impact this figure.

If an authorised person, carrying terminal 100 enters into a region 400 closer to the door—say 1 meter—then his proximity may be established as outlined above using an ultrasound signal. The door can then be unlocked or opened to allow him access, without him having to interact with the automated process in any way.

The proximity calculation may be performed either in the terminal 100 or the base unit 200. The system may specify that only base units have acoustic transmitters and terminals have receivers, or vice-versa. Alternatively, each unit 100, 200 may have both transmitters and receivers.

Even if an authorised person carrying terminal 100′ walks towards the door, he will not cause the door to be opened until he crosses the threshold 400. The threshold can be defined by the system operator.

In order to adapt a prior art telephone to incorporate ultrasound transducers for sending and/or receiving ultrasound signals, either additional components have to be introduced into the telephones, or hybrid audio/ultrasound devices are required. Additional costs are undesirable but, if sufficient volumes of product can be achieved, may be tolerable. Hybrid components invariably involve a degree of compromise in performance, but may be suitable.

Ultrasonic pressure waves are more directional than sound waves at an audible frequency. Depending on the proposed use of the system, this directionality can pose problems.

In an alternative embodiment, existing audio transducers, present in any case in all telephones, can be used for sound signalling.

Experiments have shown that the human ear is unable to discern sound pulses of low amplitude and short duration. Short duration is here intended to mean pulses of the order of a single cycle of sound energy.

A single cycle pulse of sound energy, having a short duration in the time domain, consequently has a wide spread in the frequency domain. As such, communication comprising transmission of a series of seemingly randomly distributed single cycles of sound energy does not produce any noticeable peaks in the audio frequency spectrum.

Such transmissions will therefore remain inaudible to the human ear, even though the individual pulses may comprise a cycle of sound which would be audible if transmitted continuously.

The transducers already present in portable telephone devices are capable of being operated to produce and detect single cycles of sound, but in prior art devices there is no motivation to do so.

FIG. 4 shows an exaggerated waveform 500 having the characteristics of a so-called ultra wide sound (UWS) signal. The signal is characterised by the low amplitude single cycles of sound energy transmitted at pseudo-random intervals.

If such a signal 500 were applied to a loudspeaker, there would be no sound apparent to the human ear. If the amplitude of the pulses were increased, a noise akin to white noise would be audible. The exact nature of the sound produced is dependent on the fundamental frequency of the single cycle, as this determines the spread of the signal in the frequency domain. However, amplitude levels required by embodiments of the invention are not audible.

Each transmission of sound may be considered to be split into a plurality of timeslots. Within each timeslot, there are at least two possible positions where a pulse may be present. The information content of a particular timeslot is determined by which position is occupied by a pulse. For example, a pulse in the first position could signify a ‘0’, and a pulse in the second position could indicate a ‘1’. If a timeslot comprises more than two possible positions, then multi-bit data may be represented.

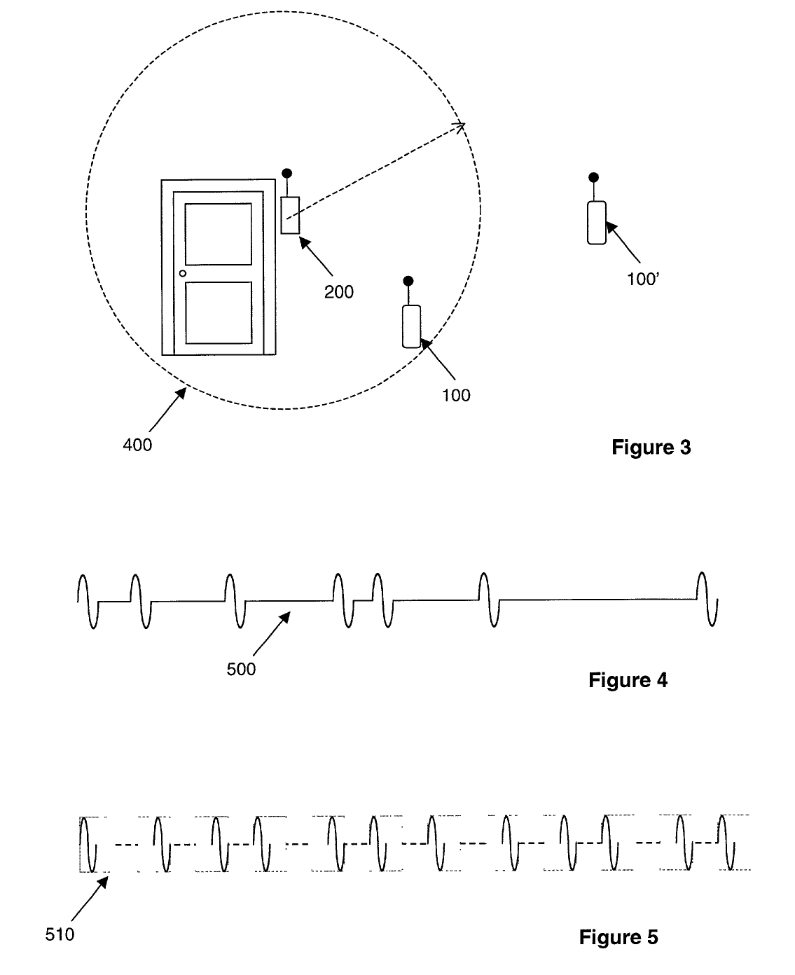

FIG. 5 illustrates the timeslot nature of the signal 500. A transmitter of UWS sends out acoustic signals comprising a number of pulses of single-cycle sound energy. The pulses are arranged to occupy timeslots. A channel of communication between a transmitting and receiving device may be defined by certain timeslot numbers. For instance, channel x is defined as comprising timeslots j, k, l, m . . . p, q, r.

Referring to the system of FIG. 1, the channel number is the data which is included in the transmission 240 sent from the base unit 200 to the terminal 100. In this way, the terminal knows how to receive the data which is comprised in the acoustic transmission which is to follow i.e. which timeslots to listen out for. Unlike the previously described embodiment which used continuous ultrasound signals, this embodiment uses UWS for the acoustic signalling.

In this embodiment the proximity is determined on the time difference between the arrival of an RF signal and an acoustic UWS signal.

The dotted boxes 510 represent the timeslots. The timeslots 510 illustrated are those picked out from all received timeslots on the basis of the received channel information.

From the received timeslots, the data transmitted can be determined from the position within the timeslot occupied by a pulse of sound energy. A ‘0’ is represented by a position at the start of a timeslot, and a ‘1’ is represented by a position at the end of a timeslot.

Thus, the data represented by the signal shown in FIG. 5 is 011010011011.

Due to the low amplitude of the single cycle sound transmissions, individual pulses may well be swamped at the receiver by noise. In order to provide a degree of statistical confidence that the information represented by any single pulse is received, each pulse may be transmitted several times in a pseudo random sequence to which the transmitter and receiver are synchronised. In this way, each bit of information is repeatedly transmitted in a timeslot known to the receiver.

If, for example, a particular bit of data is transmitted 10 times in defined locations, the receiver is able to decide, on a statistical basis, whether that bit is a ‘0’ or a ‘1’. Error coding and checking using known techniques can be added to provide a self-correcting, or at least error-checking system.

It can be seen that embodiments of the invention may be realised using a combination of transmissions of RF energy, using, e.g Bluetooth, and transmissions of acoustic energy, such as ultrasonic signals or ultra wide sound (UWS) signals as described above.

Although described in terms of single cycles of sound energy, the skilled man will be aware that the human ear reacts differently to different sound levels and frequencies, and depending on various factors such as desired range of operation and environment, the embodiments of the invention may be realised which use pulses comprising more than a single cycle of sound, provided that such pulses remain substantially inaudible to the human ear.

As well as being used to enhance proximity detection as described above, the concept of ultra wide sound may find application in fields as diverse as seismic surveying and SONAR. The low amplitude, inaudible signals may offer many benefits in these and other fields.

The present invention includes any novel feature or combination of features disclosed herein either explicitly or any generalisation thereof irrespective of whether or not it relates to the claimed invention or mitigates any or all of the problems addressed.

What is claimed is:

1. A method of wirelessly communicating between a first and second device, comprising the steps of:
transmitting a first set of data from the first device to the second device using a radio signal; and
transmitting a second set of encoded data from the first device to the second device using an acoustic signal,
wherein the first set of data comprises information related to the encoding of the second set of data.

2. A method as claimed in claim 1 wherein transmission of the radio signal is achieved using the Bluetooth communication standard.

3. A method as claimed in claim 1 or 2 wherein the acoustic signal comprises ultrasonic pressure waves.

4. A method as claimed in claim 1 or 2 wherein the acoustic signal comprises pulses of sound energy arranged to have a duration and amplitude rendering them inaudible to the human ear.

5. A method as claimed in claim 4 wherein each pulse of sound energy comprises a single cycle.

6. A method as claimed in claim 4 or 5 wherein the pulses are ordered into timeslots.

7. A method as claimed in claim 5 wherein an acoustic communication channel is defined by a pseudo-random sequence of timeslots.

8. A method as claimed in claim 7 wherein individual bits of data are transmitted a plurality of times at predefined intervals.

9. A method as claimed in any one of the preceding claims wherein the second device transmits a radio signal to the first device to verify reception of the acoustic signal.

10. A device for communicating wirelessly, comprising:
a first receiver arranged to receive a radio transmission comprising a first set of data;
a second receiver arranged to receive an acoustic transmission comprising a second set of encoded data;
a processor arranged to decode the second set of data utilising information from the first set of data.

11. A device for communicating wirelessly, comprising:
a first transmitter arranged to transmit a radio signal comprising a first set of data;
a second transmitter for transmitting an acoustic signal comprising a second set of data encoded using information from the first set of data.

12. A device as claimed in claim 10 or 11 wherein the first receiver or transmitter is operable according to the Bluetooth communication standard.

13. A device as claimed in claim 10 ,11 or 12 wherein the second receiver or transmitter is respectively operable to receive or transmit ultrasonic pressure waves.

14. A device as claimed in claim 10 ,11 or 12 wherein the second receiver or transmitter is respectively operable to receive or transmit. pulses of sound energy arranged to have a duration and amplitude rendering them inaudible to the human ear

15. A device as claimed in claim 14 wherein the second receiver is a microphone, and the second transmitter is a loudspeaker.

16. A device as claimed in claim 15 wherein the microphone and loudspeaker are additionally arranged to respectively receive voice input from a user and to output sound from a connected caller.

17. A system comprising a device according to claim 10 and a device according to claim 11.
